(19) United States
(12) Patent Application Publication
(10) Pub. No.: US 2009/0251619 A1
(43) Pub. Date: Oct. 8, 2009

(54) Remote Control Device Personalization

(75) Inventors: Joseph J. Seidel, Menlo Park, CA (US); Nadav M. Neufeld, Sunnyvale, CA (US); Pradhan S. Rao, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/099,138

(22) Filed: Apr. 7, 2008

(51) Int. Cl. H04N 5/44

(52) U.S. Cl. 348/734; 348/E05.096

(57) ABSTRACT

Techniques to personalize a remote control device are described. In an implementation, a remote control device includes a display device and one or more modules. The one or more modules are configured to determine an identity of a user and initiate one or more control functions related to control of a display of content by a client. The one or more modules are also configured to personalize a display of representations of the one or more control functions on the display device based on the determined identity of the user.

### BACKGROUND

Remote control devices were developed to expand an ability of users to control content interaction by associated clients. For example, a client may be configured as a television to consume traditional television programming and a traditional remote control device may be may be communicatively coupled to the television to initiate one or more control functions of the television. Therefore, a user may press buttons on the traditionally configured remote control device to increase or decrease volume of the television, change channels, select different sources for content, and so on.

Remote control devices today, however, may have numerous buttons to initiate numerous control functions and therefore may be considered complex by an unsophisticated user. In another example, the remote control device may have few buttons in order to simplify the users' experience, but such simplification may be frustrating to sophisticated users.

### SUMMARY

Techniques to personalize a remote control device are described. In an implementation, a remote control device includes a display device and one or more modules. The one or more modules are configured to determine an identity of a user and initiate one or more control functions related to control of a display of content by a client. The one or more modules are also configured to personalize a display of representations of the one or more control functions on the display device based on the determined identity of the user.

In an implementation, a user of a remote control device is identified. The remote control device has functionality to initiate one or more control functions to control a display of content by a client. A display of representations of the one or more control functions on the remote control device is personalized. A display of the content by the client is also personalized using configuration settings of the identified user.

In an implementation, a user of a remote control device is identified. The remote control device has functionality to initiate one or more control functions to control a display of content by a client. One or more configuration settings are located that correspond to the identified user. The one or more configuration settings are then applied to the remote control device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques to personalize a remote control device.

FIG. 2 depicts an example system showing a remote control device of FIG. 1 in greater detail as displaying representations of one or more control functions of a client that may be initiated through selection on the remote control device.

FIG. 3 is an illustration of an example system in which the remote control device of FIG. 2 is personalized for a particular user.

FIG. 4 is an illustration of an example system in which the remote control device of FIGS. 2 and 3 is personalized for another user.

FIG. 5 is a flow diagram depicting a procedure in an example implementation in which a remote control device is personalized based on an identification of a user of the remote control device.

FIG. 6 is a flow diagram depicting a procedure in an example implementation in which a remote control device and a client are personalized based on an identity of the user, and in which the personalization is dynamically updated.

### DETAILED DESCRIPTION

Overview

Techniques to personalize remote control devices are described. In an implementation, a remote controlled device includes functionality to identify a user of the remote control device. For example, the remote control device may include a fingerprint reader or other biometric recognition device that is capable of distinguishing one user from another, may accept codes entered by a user of the remote control device that may be used to identify the user, press a unique button assigned to the user, and so on.

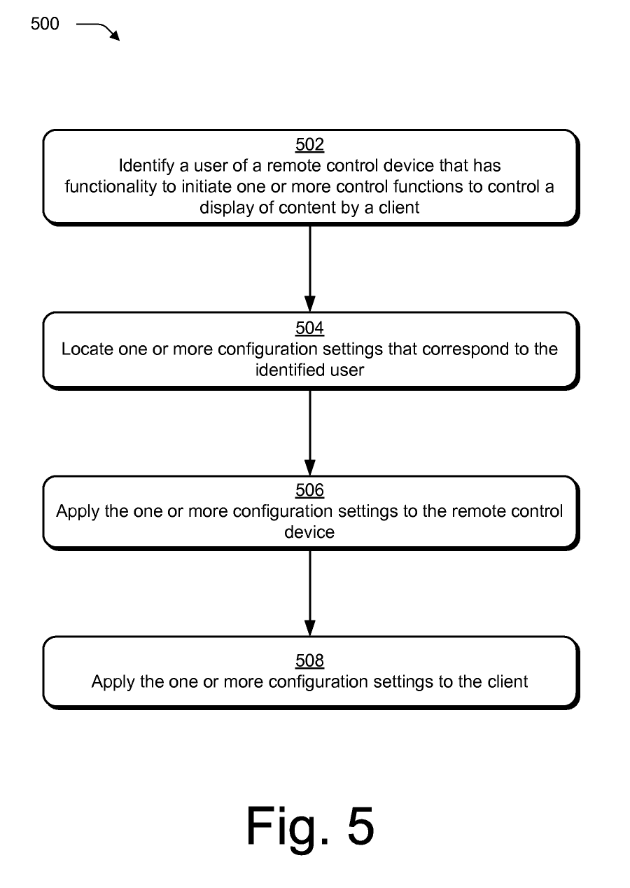

Configuration settings may then be retrieved based on the identity of the user to personalize the remote control device. For example, the configuration settings may specify a particular arrangement of representations of the control functions of the remote control device, e.g., “where” the representations are displayed by the remote control device. In another example, configuration settings may be used to specify a color or image for a background of the remote control device, representations to be used for the control functions of the remote control device (e.g., size and/or shape), which control functions are to be represented on the remote control device, and so on. In this way, the “look and feel” of the remote control device may be personalized for the user, further discussion of which may be found in relation to FIG. 5.

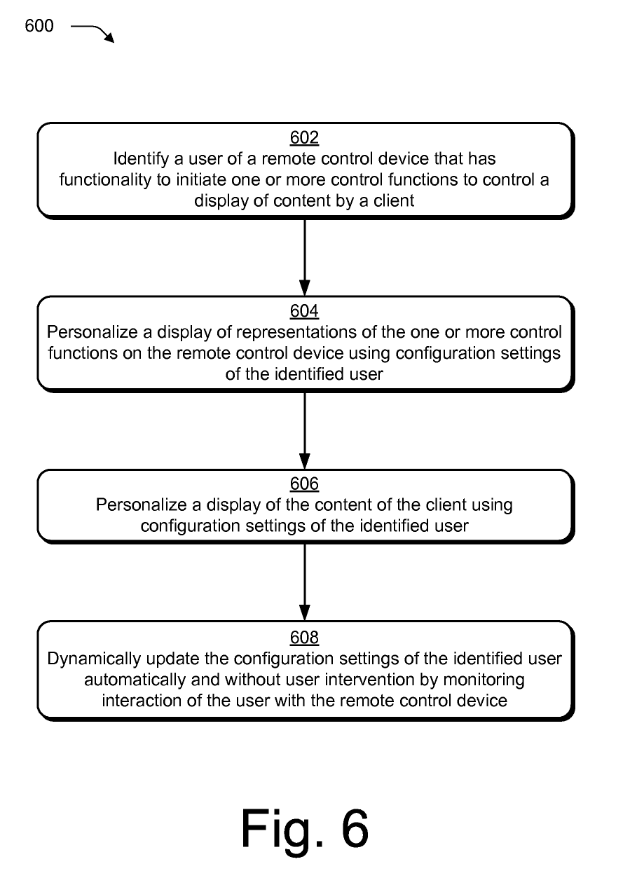

The identity of the user may also be used to configure devices other than the remote control device that was used to identify the user. The remote control device, for instance, may be configured to initiate control functions of a client that is configured as a television. The identity of the user obtained from the remote control device may also be used to personalize the television, such as to personalize an electronic program guide. A variety of other user interfaces of the television may also be personalized, such as a “splash screen” used to welcome the user when the television is turned on. The personalization of the remote control device and the client may also be linked such that “themes” may be developed to coordinate personalization of the remote control device and the client. Further discussion of client personalization may be found in relation to FIG. 6.

In the following discussion, an example environment and systems are first described that is operable to perform techniques to personalize remote control devices. Example procedures are then described that may be employed in the example environment, as well as in other environments. Although personalization is described in a television environment in the following discussion, it should be readily apparent that a wide variety of goods and/or services may also be personalized without departing from the spirit and scope thereof such as a garage door opener, an automobile door opener and an automobile, a wireless phone that may be configured to initiated control functions of another device (e.g., a vending machine), and so on.

Example Environment

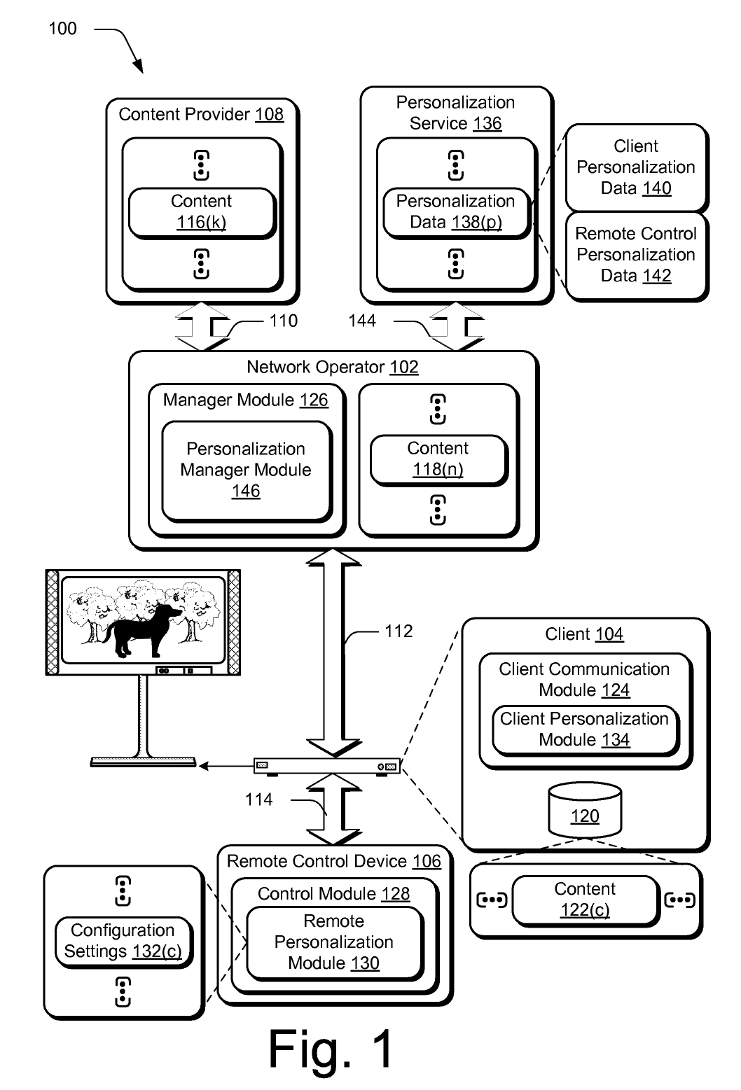

FIG. 1 is an illustration of an environment 100 in an example implementation that is operable to employ techniques to personalize a remote control device. The illustrated environment 100 includes a network operator 102 (e.g., a “head end”), a client 104, a remote control device 106 and a content provider 108 that are communicatively coupled, one to another, via network connections 110, 112, 114. In the following discussion, the network operator 102, the client 104, the remote control device 106 and the content provider 108 may be representative of one or more entities, and therefore by convention reference may be made to a single entity (e.g., the client 104) or multiple entities (e.g., the clients 104, the plurality of clients 104, and so on). Additionally, although a plurality of network connections 110-114 are shown separately, the network connections 110-114 may be representative of network connections achieved using a single network or multiple networks, e.g., network connections 110, 112 may be implemented via the internet and network connection 114 may be implemented via a local network connection, such as via infra red, a radio frequency connection, and so on. In another example, network connection 114 may also be implemented via the internet.

The client 104 may be configured in a variety of ways. For example, the client 104 may be configured as a computer that is capable of communicating over the network connections 112, 114, such as a television, a mobile station, an entertainment appliance (e.g., a game console), a set-top box communicatively coupled to a display device as illustrated, a wireless phone, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes).

Communication of content to the client 104 may be performed in a variety of ways. For example, the client 104 may be communicatively coupled to the content provider 108 (which may be representative of one or more content providers) using a packet-switched network, e.g., the Internet. Accordingly, the client 104 may receive one or more items of content 116(k), where “k” can be any integer from 1 to “K” directly from the content provider 108, e.g., via one or more websites. The content 116(k) may include a variety of data, such as television programming, video-on-demand (VOD) files, one or more results of remote application processing, and so on. A variety of other examples are also contemplated, such as by using an indirect distribution example in which the content 116(k) is communicated over the network connection 110 to the network operator 102.

Content 116(k), as illustrated in FIG. 1, is communicated via the network connection 110 is received by the network operator 102 and may be stored as one or more items of content 118(n), where “n” can be any integer from “1” to “N”. The content 118(n) may be the same as or different from the content 116(k) received from the content provider 108. The content 118(n), for instance, may include additional data for broadcast to the client 104. For example, the content 118(n) may include electronic program guide (EPG) data from an EPG database for broadcast to the client 104 utilizing a carousel file system and an out-of-band (OOB) channel. Distribution from the network operator 102 to the client 104 over network connection 112 may be accommodated in a number of ways, including cable, radio frequency (RF), microwave, digital subscriber line (DSL), and satellite.

The client 104, as previously stated, may be configured in a variety of ways to receive the content 118(n) over the network connection 114. The client 104 typically includes hardware and software to transport and decrypt content 118(n) received from the network operator 102 for output to and rendering by the illustrated display device. Although a display device is shown, a variety of other output devices are also contemplated, such as speakers. Further, although the display device is illustrated separately from the client 104, it should be readily apparent that the client 104 may also include the display device as an integral part thereof.

The client 104 may also include digital video recorder (DVR) functionality. For instance, the client 104 may include a storage device 120 to record content 118(n) as content 122(c) (where “c” can be any integer from one to “C”) received via the network connection 112 for output to and rendering by the display device. The storage device 120 may be configured in a variety of ways, such as a hard disk drive, a removable computer-readable medium (e.g., a writable digital video disc), and so on. Thus, content 122(c) that is stored in the storage device 120 of the client 104 may be copies of the content 118(n) that was streamed from the network operator 102. Additionally, content 122(c) may be obtained from a variety of other sources, such as from a computer-readable medium that is accessed by the client 104, and so on. For example, content 122(c) may be stored on a digital video disc (DVD) when the client 104 is configured to include DVD functionality.

The client 104 includes a client communication module 124 that is representative of functionality of the client 104 to control content interaction on the client 104, such as through the use of one or more “control functions”. The control functions may include a variety of functions to control output of content, such as to control volume, change channels, select different inputs, configure surround sound, and so on. The control functions may also provide non-linear playback of the content 122(c) (i.e., time shift the playback of the content 122(c)) such as pause, rewind, fast forward, slow motion playback, and the like. For example, during a pause, the client 104 may continue to record the content 118(n) in the storage device 120 as content 122(c). The client 104, through execution of the client communication module 124, may then playback the content 122(c) from the storage device 120, starting at the point in time the content 122(c) was paused, while continuing to record the currently-broadcast content 118(n) in the storage device 120 from the network operator 102.

When playback of the content 122(c) is requested, the client communication module 124 retrieves the content 122(c). The client communication module 124 may also restore the content 122(c) to the original encoded format as received from the content provider 108. For example, when the content 122(c) is recorded on the storage device 120, the content 122(c) may be compressed. Therefore, when the client communication module 124 retrieves the content 122(c), the content 122(c) is decompressed for rendering by the display device.

The network operator 102 is illustrated as including a manager module 126. The manager module 126 is representative of functionality to configure content 118(n) for output (e.g., streaming) over the network connection 112 to the client 104. The manager module 126, for instance, may configure content 116(k) received from the content provider 108 to be suitable for transmission over the network connection 112, such as to “packetize” the content for distribution over the Internet, configuration for a particular broadcast channel, and so on.

Thus, in the environment 100 of FIG. 1, the content provider 108 may broadcast the content 116(k) over a network connection 110 to a multiplicity of network operators, an example of which is illustrated as network operator 102. The network operator 102 may then stream the content 118(n) over a network connection 112 to a multitude of clients, an example of which is illustrated as client 104. The client 104 may then store the content 118(n) in the storage device 120 as content 122(c), such as when the client 104 is configured to include digital video recorder (DVR) functionality, and/or output the content 118(n) directly.

The remote control device 106 is illustrated as including a control module 128 that is representative of functionality to control operation of the remote control device 106. The control module 128, for instance, is representative of functionality to initiate control functions of the client 104. For example, the control module 128 may be configured to receive inputs related to selection of representations of control functions, such as a selection of a “volume up” representation on the remote control device 106 using a button. Data representing this selection may then be communicated via network connection 114 to the client 104 that causes the client 104 (e.g., the client communication module 124) to increase the volume. A variety of other control functions may also be initiated by the control function module 128 as previously described.

The control module 128 is further illustrated as including a remote personalization module 130 that is representative of functionality to personalize the remote control device 106. The remote personalization module 130, for instance, may employ one or more configuration settings 132(c) (where “c” may be an integer from one to “C”) that are specific to a particular identified user. For example, the control module 128 may also be representative of functionality of the remote control device 106 to identify a particular user such as through a fingerprint scan or other biometric reading, e.g., using one or more techniques to measure and/or analyze human body characteristics such as hand measurements.

Once the user of the remote control device 106 is identified, the remote personalization module 130 may retrieve one or more configuration settings 132(c) that are particular to the identified user to personalize the remote control device 106. Likewise, the client 104 may also be personalized through use of a client personalization module 134.

Personalization of the remote control device 106 may also be aided by the client 104 or other devices and therefore is not limited to performance by the remote control device 106, itself. For example, the remote personalization module 130 may receive an input (e.g., an identifier) from a user of the remote control device 106 that may be used to differentiate a user from another user. The remote control device 106 may then forward this identifier to the client 104 for use by the client personalization module 134 to identify the user. Once the user is identified by the client 104, data may be communicated by the client 104 to the remote control device 106 to personalize the remote control device 106 by the remote personalization module 130. A variety of other techniques may also be used to personalize the remote control device 106 and/or the client 104, an example of which may be found beginning in relation to the following figure.

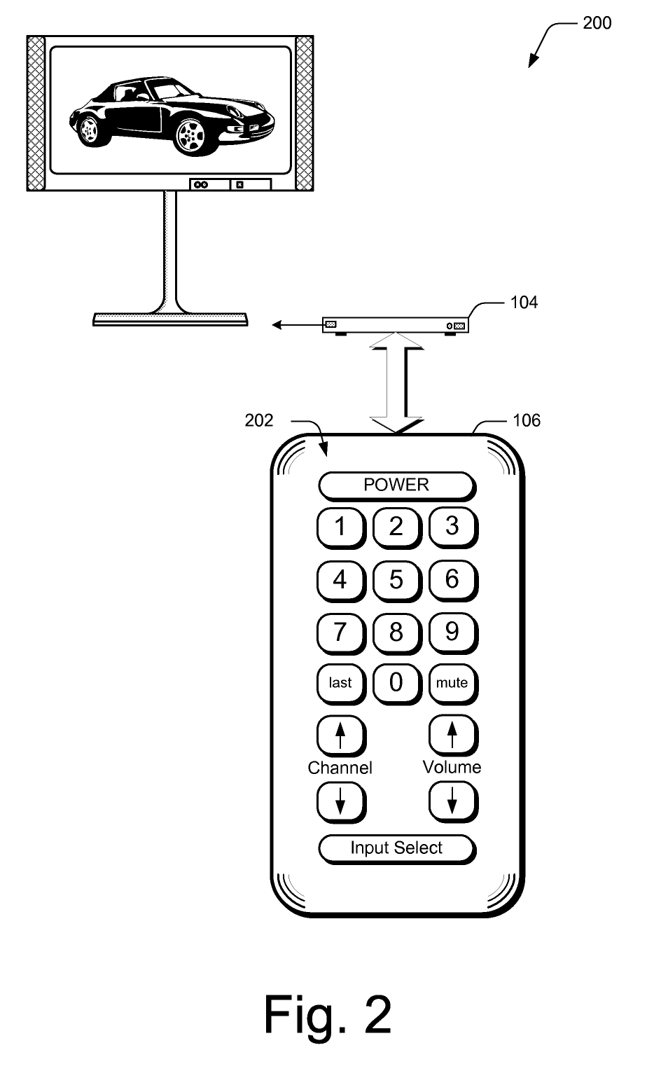

FIG. 2 depicts an example system 200 showing the remote control device 106 in greater detail as displaying representations 202 of one or more control functions of the client 104 that may be initiated through selection on the remote control device 106. The illustrated remote control device 106 includes a display device (e.g., a touch screen) that consumes approximately half of an outer surface of the remote control device thereby giving the remote control device an appearance of a “glassy brick”.

In another implementation, the display device of the remote control device 104 covers at least forty percent of the outer surface of the remote control device 104. In a further implementation, the display device consumes, approximately, an outer surface of the remote control device 106 that is viewable by a user when placed on a surface (e.g., a top of a table) and/or grasped in a hand of the user, e.g., the illustrated outer surface of the remote control device 106 in FIG. 2. A variety of other implementations are also contemplated, such as implementations in which the display device of the remote control device 106 includes more or less than the previously described amounts of the outer surface of the remote control device 106.

The display device may be implemented such that representations of control functions and other data are reconfigurable and therefore may be personalized on the remote control device 106. For example, different portions of the display device of the remote control device 106 may be configured to detect contact and/or proximity of an object to the display device such that different portions of the display device are selectable. A variety of different techniques may be used to detect selection, such as through resistive techniques, surface acoustic waves, capacitive, infrared, use of strain gauges, optical imaging, dispersive signal technology, acoustic pulse recognition, frustrated total internal reflection, and so on. Using these techniques, representations of control functions may be personalized in a variety of ways (e.g., such as different sizes, shapes, arrangements, and so on) such that each is selectable by a user, further discussion of which may be found below.

By selecting one or more of the representations 202, a user may supply an input to initiate the represented control function by the client 104. As illustrated by the remote control device 106 of FIG. 2, for instance, a user may select a “power” representation, one or more numbers to select a channel, “mute”, “last”, “channel up”, “channel down”, “volume up”, “volume down” and “input select”. Thus, the remote control device 106 may communicate with the client 104 to control output of content by the client 104. The remote control device 106 of FIG. 2 is illustrated in a default mode such that the representations 202 are not personalized for a particular user.

The remote control device 106 of FIG. 2 may also include functionality to determine an identity of a user, which may then be used to personalize the remote control device 106. For example, the display device of the remote control device 106 may include functionality to differentiate a thumb of one user from a thumb of another user (e.g., size and/or shape), detect a fingerprint, and so on. Once the identity of the user is established, representations and other features of the remote control device 106 may be personalized, an example of which may be found in relation to the following figure.

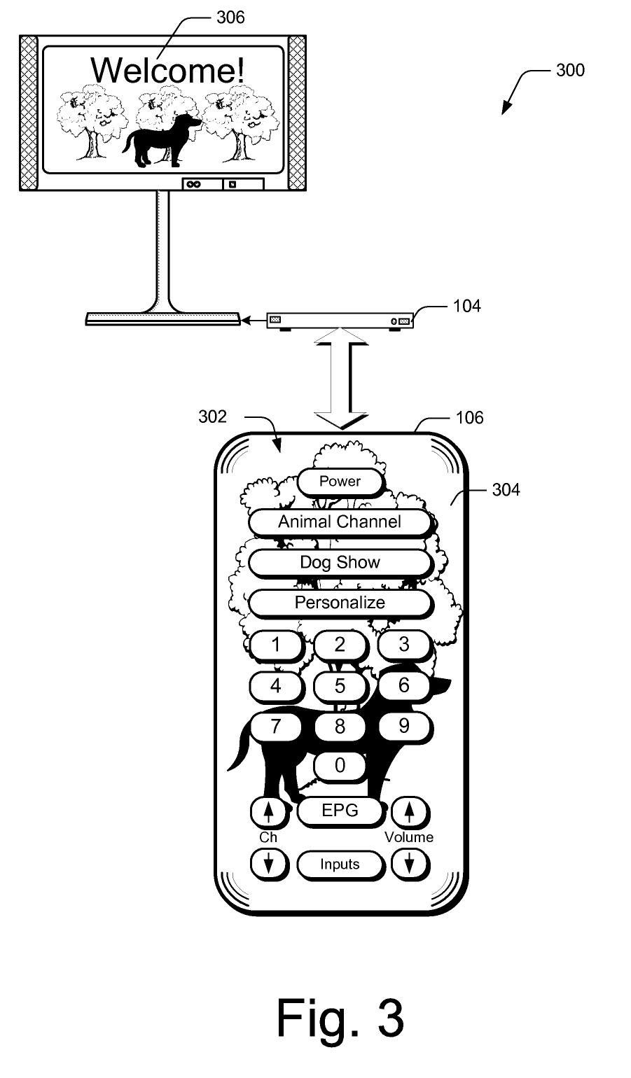

FIG. 3 illustrates an example system 300 in which the remote control device 106 is personalized for a particular user. The remote control device 106 includes a plurality of representations 302 that are personalized based on the identity of the user. For example, the representations 302 include a representation for “power”, representations that form a numeric keypad, “channel up” and “channel down” representations, “volume up” and “volume down” representations that correspond to the representations 202 of the remote control device 106 of FIG. 2.

However, the size and arrangement of those representations, one to another, has changed to be positioned according to the configuration settings 132(c) that were retrieved based on the identity of the user. For example, the size and shape of the representations of the numeric keypad of the remote control device 106 of FIG. 3 have been changed when compared with the representations of the numeric keypad of the remote control device 106 of FIG. 2. A similar change may also be noticed when comparing the representations of the power control function of FIGS. 2 and 3, respectively.

Additionally, the arrangement of the representations of the control functions has been changed. For instance, the representations of the numeric keypad as well as the representations to change the channel and the volume have been positioned lower on the display device of the remote control device 106 of FIG. 3 when compared with the remote control device 106 of FIG. 2.

Further, different control functions are represented by the remote control device 106 of FIG. 3 when compared with a remote control device of FIG. 2. For example, configuration settings 132(c) that were retrieved based on the identity of the user may specify particular broadcast channels of interest, an example of which is illustrated in FIG. 3 as “Animal Channel”. The configuration settings 132(c) may also specify particular content of interest to the user, an example of which is illustrated as “Dog Show”. For instance, The remote control device 106 may be personalized to have a set of tiles at the top of the remote, where each tile represents a user's favorite channel and/or content. In one embodiment, five such tiles may be displayed to represent the top five favorite channels or content of the user. A favorite channel or content may be manually specified by the user, determined based on monitored usage by that user or the family, and so on.

Yet further, the remote control device 106 may also include a background 304 that is personalized based on the configuration settings 132(c). In illustrated example of FIG. 3, the background 304 includes a dog and a tree that is output to substantially consume an available display area of the display device of the remote control device 106. Thus, in this example the background surrounds the representations 302 of the control functions. The background 304 may also be correlated with personalization of the client 104.

For example, a “splash” screen 306 is illustrated in FIG. 3 that may be used to welcome a user when the client 104 is “powered on”. The splash screen 306 is personalized based on the configuration settings 132(c) that were retrieved based on the identity of the user of the remote control device 106. As should be readily apparent, personalization of the splash screen 306 provides a similar “look and feel” to the output of the client 104 and a display of the remote control device 106. In this way, a “theme” may be realized to personalize both the remote control device 106 and a client 104, further discussion of which may be found in relation to FIG. 6.

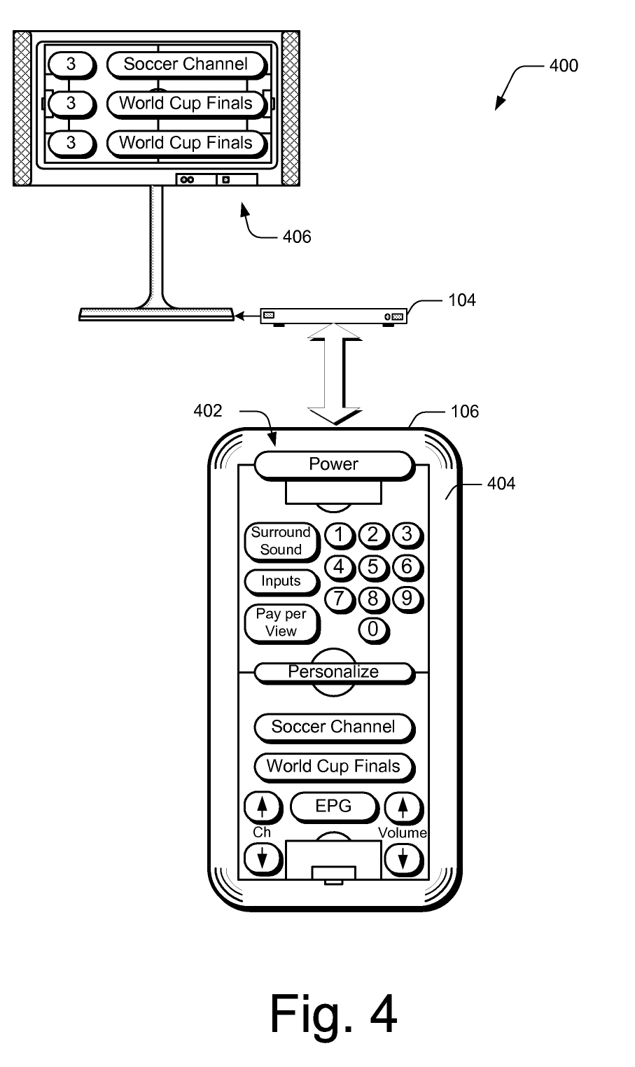

FIG. 4 illustrates an example system 400 in which the remote control device 106 of FIGS. 2 and 3 is personalized for another user. The system 400 of FIG. 4 includes a preconfigured theme that may be obtained by a user. As before, the remote control device 106 includes a plurality of representations 402 and a background 404. In this instance, the representations 402 and the background 404 follow a “soccer” theme.

Likewise, an electronic program guide 406 output by the client 104 also follows the soccer theme, such as by including a background that mimics a soccer field. The electronic program guide 406, and more particularly representations of content, may also be personalized. For example, particular representations that are used to represent content as well as which content is included in the electronic program guide 406 may be personalized. Data used to provide the personalization of the remote control device 106 and/or the client 104 may be obtained from a variety of sources.

Returning now to FIG. 1, the environment 100 is illustrated as including a personalization service 136 having one or more items of personalization data 138(p), where “p” may be an integer between one and “P”. The personalization data 138(p) is illustrated as including client personalization data 140 that is configured for use by the client 104 and remote control personalization data 142 that is configured for use by the remote control device 106. The personalization data 138(p) may be provided to the client 104 and/or the remote control device 106 in a variety of ways. For instance, the personalization data 138(p) may be provided over a network connection 144 to the network operator 102.

The manager module 126 of the network operator 102 is illustrated as including a personalization manager module 146, which is representative of functionality of the network operator 102 to manage personalization of the client 104 and the remote control device 106 over the network connection 112. The personalization manager module 146, for instance, may provide an interface that is accessible by a user of the client 104 over the network connection 112 to obtain (e.g., purchase) themes for use by the client 104 and/or the remote control device 106. For example, the themes may be configured as advertisements provided free of charge by respective advertisers.

Personalization of the remote control device 106 and/or the client 104 may also be performed directly by a user of the remote control device 106. The user, for instance, may specify a particular photo to be used as a background on the remote control device 106, particular representations to be used for control functions on the remote control device 106, which control functions are to be represented on the remote control device 106, and so on. For example, the user may “drag-and-drop” representations of control functions using a touchscreen of the remote control device 106.

Additionally, personalization may be based upon monitored user action with the remote control device 106. The remote personalization module 130, for instance, may monitor which channels are most frequented by the user and provide representations of those channels on the remote control device 106, favorite television programs that are viewed by the user, and so on. In this way, personalization of the remote control device and/or a client 104 may be dynamically updated without specific intervention on the part of the user.

Referring generally now to FIGS. 2-4, different templates may be provided for personalization of the remote control device 106 and/or the client 104 based on an identity of a user and corresponding sophistication assigned to the identity. For example, the remote control device 106 of FIG. 1 displays a relatively unsophisticated arrangement of representations of control functions having a size that may be desirable for an unsophisticated user. In another example, the remote control device 106 of FIG. 3 illustrates an increasingly more sophisticated personalization template in which representations of additional functionality are shown, e.g., “EPG” and “inputs” that may be desirable for a more sophisticated user than the user of the remote control device 106 of FIG. 2. Likewise, FIG. 4 depicts another example of the remote control device 106 as employing a template that is even more sophisticated in that it includes representations of additional control functions, e.g., “surround sound”. Thus, in this example an identity of a user may be associated with a particular template for representations having varying sophistication. In this way, the remote control device 106 of FIG. 2 may be personalized for a child, the remote control device 106 of FIG. 3 may be personalized for an adult and the remote control device 106 of FIG. 4 may be personalized for a “power user”. A variety of other examples are also contemplated.

In an implementation, the identity of the user may be “roamed” between multiple remote control devices 106. For example, as previously described the client 104 may be employed to identify the user. Continuing with this example, use of any one of the remote control devices in a household may cause communication with this central point to identify the user and/or receive data to personalize the remote control device 106. Thus, in this continued example personalization may “roam” to multiple remote control devices without having to be manually “set up” for each of the remote control devices in the household individually.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to personalize a remote control device are platform-independent, meaning that the techniques may be implemented on a variety of commercial computing platforms having a variety of processors.

Example Procedures

The following discussion describes personalization techniques that may be implemented utilizing the previously described environment, systems, user interfaces and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and systems 200-400 of FIGS. 2-4, respectively.

FIG. 5 depicts a procedure 500 in an example implementation in which a remote control device is personalized based on an identification of a user of the remote control device. A user is identified of a remote control device that has functionality to initiate one or more control functions to control a display of content by a client (block 502). For example, the remote control device 106 may include one or more biometric sensors to obtain biometric data from the user. A variety of different biometric data may be used, such as a fingerprint, size and/or shape of a user's finger or thumb, temperature, voice input, and so on. In an implementation, the biometric data is used to differentiate one user from a plurality of other users for which the remote control device 106 may be personalized. A variety of other non-biometric techniques are also contemplated, such as by receiving an input (e.g., a unique code) that is communicated to the client 104 by the remote control device 106 to identify the user, e.g., by forming the communication by the remote control device 106. The client 104 may then communicate the identity and/or data to the remote control device 106 to personalize the remote control device 106.

One or more configuration settings are located that correspond to the identified user (block 504). The remote control device 106, for instance, may locally store configuration settings 132(c) in a storage device. In another example, configuration settings 132(c) may be obtained via a network connection 114, such as from the client 104 and/or the network operator 102. A variety of other instances are also contemplated, such as a third-party service that stores the configuration settings 132(c) and personalization data 138(p) for retrieval by the remote control device 106.

The one or more configuration settings are then applied to the remote control device (block 506). A wide variety of configuration settings 132(c) may be used to personalize a remote control device 106. For example, the configuration settings 132(c) may specify a particular color of representations and/or a background to be used with the remote control device 106, a particular image to be used as a background for the remote control device 106, which control functions are to be represented by the remote control device 106, a “screen saver” that is displayed by the remote control device 106 after a predetermined “time out” period, and so on.

The one or more configuration settings may also be applied to the client (block 508). The configuration settings 132(c), for instance, may be communicated from the remote control device 106 over the network connection 114 to the client 104. A client personalization module 134 may then use the configuration settings 132(c) to personalize an output of content by the client 104, such as to personalize an electronic program guide and/or a splash screen, further discussion of which may be found in relation to the following figure.

FIG. 6 depicts a procedure 600 in an example implementation in which a remote control device and a client are personalized based on an identity of the user, and in which the personalization is dynamically updated. A user of a remote control device is identified that has functionality to initiate one or control functions to control a display of content by a client (block 602). As previously described in relation to the example environment, the user may be identified in a variety of ways, including through use of biometric data.

A display of representations of the one or more control functions on the remote control device is personalized using configuration settings in the identified user (block 604). A display of the content of a client may also be personalized using configuration settings of the identified user (block 606). As previously described, the personalization may be performed in a variety of ways, such as to personalize a color, size, shape, arrangement, and so on of the representations of the remote control device 106 and/or a client 104.

The configuration settings of the identified user are dynamically updated automatically and without user intervention a monitoring interaction of the user with a remote control device (block 608). For example, the remote personalization module 130 may monitor interaction of the user with the remote control device 106. Based on this monitoring, the remote personalization module 130 may update the configuration settings 132(c), such as to choose which representations of content are displayed with the remote control device 106 and/or an arrangement of those representations, one to another. In another implementation, however, it should be readily apparent that the user may also manually personalize the remote control device 106 and/or the client, such as to “drag and drop” representations of the control functions to rearrange the representations.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying a user of a remote control device that has functionality to initiate one or more control functions to control a display of content by a client;
locating one or more configuration settings that correspond to the identified user; and
applying the one or more configuration settings to the remote control device.

2. A method as described in claim 1, wherein the identifying includes reading a fingerprint of the user, use of one or more biometric techniques, use of a unique identifier, or using voice recognition by the remote control device.

3. A method as described in claim 1, wherein the one or more control functions include functionality to select particular channels.

4. A method as described in claim 1, wherein the locating is performed by searching data that is local to the remote control device by the remote control device.

5. A method as described in claim 1, wherein the one or more configuration settings specify a background to be displayed by the remote control device.

6. A method as described in claim 1, wherein the one or more configuration settings specify representations that are to be used to represent the one or more control functions on a display of the remote control device.

7. A method as described in claim 1, wherein the one or more configuration settings specify arrangement of representations, one to another, that are to be used to represent the one or more control functions on a display of the remote control device.

8. A method as described in claim 1, wherein the one or more configuration settings specify which of the one or more control functions are to be represented on a display of the remote control device.

9. A method as described in claim 1, wherein the one or more configuration settings specify a display theme to be employed by the remote control device.

10. A method as described in claim 1, further comprising applying at least one said configuration setting to the client to personalize the client.

11. A method comprising:
identifying a user of a remote control device that has functionality to initiate one or more control functions to control a display of content by a client; and
personalizing a display of representations of the one or more control functions on the remote control device and a display of the content by the client using configuration settings of the identified user.

12. A method as described in claim 11, wherein the content includes a splash screen.

13. A method as described in claim 11, wherein:
the content is an electronic program guide; and
the personalizing of the display of the content includes a selection of a particular background to be used for display of the electronic program guide.

14. A method as described in claim 11, wherein the personalizing of the display of the representations of the one or more control functions includes specifying which of the one or more control functions are to be represented on the remote control device and arrangement of representations of the one or more control functions, one to another.

15. A method as described in claim 11, wherein the personalizing is dynamic such that configuration settings that are used to perform the personalizing are updated automatically and without user invention based on monitored interaction of the identified user with the remote control device.

16. A remote control device comprising:
a display device; and
one or more modules to:
determine an identity of a user;
initiate one or more control functions related to control of a display of content by a client; and
personalize a display of representations of the one or more control functions on the display device based on the determined identity of the user.

17. A remote control device as described in claim 16, wherein:
the display device is configured as a touch screen; and
the one or more representations are displayable and selectable using the touch screen to initiate the one or more control functions, respectively.

18. A remote control device as described in claim 16, wherein the one or more modules are configured to personalize the display of representations of the one or more control functions using data received from the client.

19. A remote control device as described in claim 16, wherein the one or more modules are further configured to output the determined identity to the client to personalize display of the content by the client.

20. A remote control device as described in claim 16, wherein the one or more modules are further configured to determine the identity by forming a communication to be communicated to the client which includes an input supplied by the client and receive the identity found by the client using the input.
